(19) United States
(12) Patent Application Publication
(10) Pub. No.: US 2025/0241373 A1
(43) Pub. Date: Jul. 31, 2025

(54) CIRCULATING LIQUID-GUIDE ATOMIZATION DEVICE

(71) Applicant: Deliang SUN, Shenzhen (CN)

(72) Inventor: Deliang SUN, Shenzhen (CN)

(21) Appl. No.: 19/095,085

(22) Filed: Mar. 31, 2025

(30) Foreign Application Priority Data
Jan. 31, 2024 (CN) 202410143314.0

(51) Int. Cl. A24F 40/48; A24F 40/10

(52) U.S. Cl. CPC A24F 40/48; A24F 40/10

(57) ABSTRACT

The present application discloses a circulating liquid-guide atomization device. The liquid holding tray, the liquid permeation core and the atomization sheet are all mounted in the housing, one end of the liquid permeation core is connected with the liquid holding tray, the other end thereof is connected with the atomization sheet, the liquid outlet mechanism is connected with the housing and is disposed to extend into the housing, the position of the liquid outlet mechanism corresponds to the position of the liquid holding tray, the liquid outlet mechanism is used for spraying a liquid onto the liquid holding tray, the liquid permeation core is used for guiding the liquid to the atomization sheet such that the liquid is atomized by the atomization sheet, and the liquid holding tray is used for collecting and guiding excess liquid such that the excess liquid flows back to the liquid outlet mechanism.

### CROSS-REFERENCE TO RELATED APPLICATIONS

The application claims priority to Chinese patent application No. 202410143314.0, filed on Jan. 31, 2024, the entire contents of which are incorporated herein by reference.

### TECHNICAL FIELD

The present application relates to the technical field of atomization, in particular to a circulating liquid-guide atomization device.

### BACKGROUND

At present, in the fields of medical treatment, aromatherapy and electronic cigarettes, circulating liquid-guide atomization devices have been needed. For most of current circulating liquid-guide atomization devices in the market, a liquid storage bottle stands upside down on an atomizer, a liquid flows downwards from the inside of the liquid storage bottle to the atomizer by means of its gravity, and a liquid atomization function is achieved by means of the atomizer. However, in such a way, the liquid flowing to the atomizer is higher in flow or liquid flow is out of control, a great deal of liquid is atomized at the same time, which results in larger volumes of formed mist particles, poorer atomization effect and poorer user experience.

To this end, it is particularly important to design and manufacture a circulating liquid-guide atomization device with a good atomization effect, particularly in liquid atomization.

### SUMMARY

An object of the present application is to provide a circulating liquid-guide atomization device which can reasonably control a flow of a liquid, effectively reduce volumes of mist particles formed by atomization, improve an atomization effect, and improve user experience.

The present application is implemented by adopting the following technical solutions:

a circulating liquid-guide atomization device includes a housing, a liquid outlet mechanism, and an atomization module mounted in the housing and used for atomizing an external liquid, wherein the atomization module includes an atomization sheet mounted in the housing, the liquid outlet mechanism is connected with the housing and is disposed to extend into the housing, and the liquid outlet mechanism is used for spraying the liquid onto the atomization sheet.

Optionally, the atomization sheet is provided with a liquid permeation core and a liquid holding tray, the liquid permeation core and the liquid holding tray are both located in the housing, one end of the liquid permeation core is connected with the liquid holding tray, the other end thereof is connected with the atomization sheet, a liquid outlet position of the liquid outlet mechanism is located above the liquid holding tray and where a liquid is sprayed onto the liquid holding tray, the liquid permeation core is used for guiding the liquid from the liquid holding tray to the atomization sheet such that the liquid is atomized by the atomization sheet, and the liquid holding tray is used for collecting and guiding excess liquid to flow back to an external liquid storage bottle.

Optionally, the liquid holding tray includes a tray body and a connecting sleeve, a drain outlet is formed in the tray body, the connecting sleeve is connected with the liquid holding tray, is disposed to penetrate through the liquid holding tray, and communicates with the drain outlet, and the liquid permeation core is partially disposed in the connecting sleeve.

Optionally, an axial direction of the connecting sleeve is disposed to be inclined to a plane where the tray body is located, and an axial direction of the liquid permeation core is the same as the axial direction of the connecting sleeve and is perpendicular to a plane where the atomization sheet is located.

Optionally, a guide chute is formed in the tray body, the drain outlet is disposed in a bottom wall of the guide chute, and the bottom wall of the guide chute is gradually inclined downwards in a direction close to the drain outlet.

Optionally, a liquid blocking boss is enclosed on an edge of the tray body, an overflow groove is formed in the liquid blocking boss, the position of the overflow groove corresponds to the position of the liquid outlet mechanism, and the overflow groove is used for allowing a liquid overflowing out of the tray body to flow back to the liquid outlet mechanism.

Optionally, the liquid permeation core is further connected with a positioning spring, a first annular boss is disposed on a circumferential surface of the liquid permeation core, a second annular boss is disposed in the connecting sleeve, the positioning spring is sleeved outside the liquid permeation core and is disposed in the connecting sleeve, one end of the positioning spring abuts against the first annular boss, the other end thereof abuts against the second annular boss, and the liquid permeation core abuts against the atomization sheet.

Optionally, the liquid outlet mechanism includes an air pump, a venturi tube, and a liquid storage bottle, the air pump and the liquid storage bottle are both connected with the venturi tube, the venturi tube is mounted in the housing and is disposed obliquely above the liquid holding tray, and the air pump is used for introducing air to the venturi tube so as to suck the liquid in the liquid storage bottle into the venturi tube and spray the liquid onto the liquid holding tray.

Optionally, the venturi tube includes an air inlet tube section, a connecting tube section, and a liquid inlet tube section, wherein the air inlet tube section and the connecting tube section are coaxially disposed and are connected with each other, the internal diameter of the air inlet tube section is greater than the internal diameter of the connecting tube section, the liquid inlet tube section is connected to the connecting tube section and is disposed to be perpendicular to the connecting tube section, the air inlet tube section is connected with the air pump, the liquid inlet tube section is connected with the liquid storage bottle, and the connecting tube section is used for spraying the liquid onto the liquid holding tray.

Optionally, the liquid outlet mechanism includes a water pump, a water pump liquid inlet tube, and a water pump liquid outlet tube, two ends of the water pump liquid inlet tube are respectively connected with the water pump and a liquid delivery tube of the external liquid storage bottle, two ends of the water pump liquid outlet tube are respectively connected with the water pump and the housing, the end connected with the housing is located obliquely above the liquid holding tray, and the water pump is used for sucking the liquid in the liquid storage bottle into the water pump liquid outlet tube and spraying the liquid onto the liquid holding tray.

Optionally, the liquid outlet mechanism includes a peristaltic pump, a peristaltic liquid inlet tube, and a peristaltic liquid outlet tube, two ends of the peristaltic liquid inlet tube are respectively connected with the peristaltic pump and the liquid delivery tube of the external liquid storage bottle, two ends of the peristaltic liquid outlet tube are respectively connected with the peristaltic pump and the housing, the end connected with the housing is located obliquely above the liquid holding tray, and the peristaltic pump is used for sucking the liquid in the liquid storage bottle into the peristaltic liquid outlet tube and spraying the liquid onto the liquid holding tray.

Optionally, the housing includes a shell, an upper cover, a gland, and a sealing ring, the upper cover and the gland are both connected to the shell, a mist outlet is formed in the upper cover, the gland is connected with the sealing ring, an annular limiting groove is formed in an inner side wall of the sealing ring, and the atomization sheet is clamped in the annular limiting groove.

Optionally, the housing further includes a silencing sheet, the silencing sheet is mounted on an inner side of the upper cover and forms a mist outlet channel together with the upper cover, a through hole is formed in the silencing sheet, and the through hole communicates with the mist outlet via the mist outlet channel.

Optionally, the housing includes a shell, a housing connecting section is formed on a position where the shell is connected with the external liquid storage bottle, and an inner wall, close to the housing connecting section, of the shell is obliquely disposed and forms the lowest position on a position where the housing connecting section is connected.

The circulating liquid-guide atomization device provided by the present application has the following beneficial effects:

according to the circulating liquid-guide atomization device provided by the present application, the liquid holding tray, the liquid permeation core and the atomization sheet are all mounted in the housing, one end of the liquid permeation core is connected with the liquid holding tray, the other end thereof is connected with the atomization sheet, the liquid outlet mechanism is connected with the housing and is disposed to extend into the housing, the position of the liquid outlet mechanism corresponds to the position of the liquid holding tray, the liquid outlet mechanism is used for spraying a liquid onto the liquid holding tray, the liquid permeation core is used for guiding the liquid to the atomization sheet to form a thin oil film on a surface of the atomization sheet such that the liquid is atomized stably and reliably by the atomization sheet, and the liquid holding tray is used for collecting and guiding excess liquid such that the excess liquid flows back to the liquid outlet mechanism. Compared with the prior art, due to the adoption of the liquid outlet mechanism with the position corresponding to the position of the liquid holding tray and the atomization sheet connected with the liquid holding tray via the liquid permeation core, the circulating liquid-guide atomization device provided by the present application can reasonably control a flow of a liquid, effectively reduce volumes of mist particles formed by atomization, improve an atomization effect, and improve user experience.

### BRIEF DESCRIPTION OF DRAWINGS

In order to describe technical solutions in embodiments of the present application more clearly, accompanying drawings required for describing the embodiments will be briefly introduced below.

FIG. 1 is a schematic structural diagram of a circulating liquid-guide atomization device provided in an embodiment of the present application;

FIG. 2 is a schematic structural diagram of spacing a liquid outlet mechanism and a liquid holding tray in a circulating liquid-guide atomization device provided in an embodiment of the present application;

FIG. 3 is an exploded view of connection between a liquid holding tray and an atomization sheet via a liquid permeation core in a circulating liquid-guide atomization device provided in an embodiment of the present application;

FIG. 4 is a schematic structural diagram of a liquid holding tray in a circulating liquid-guide atomization device provided in an embodiment of the present application;

FIG. 5 is a sectional view of a circulating liquid-guide atomization device provided in an embodiment of the present application;

FIG. 6 is an exploded view of connection between a venturi tube and a fixing sleeve in FIG. 5;

FIG. 7 is a schematic structural diagram of a housing in a circulating liquid-guide atomization device provided in an embodiment of the present application;

FIG. 8 is an exploded view of connection between an upper cover and a silencing sheet in FIG. 7;

FIG. 9 is a first schematic structural diagram of an implementation in which a core component of a liquid outlet mechanism is a water pump;

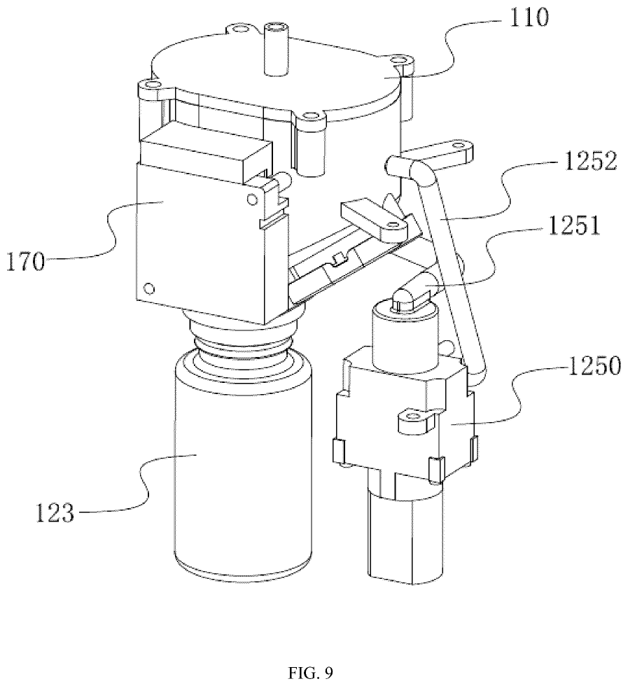

FIG. 10 is a second schematic structural diagram of an implementation in which a core component of a liquid outlet mechanism is a water pump;

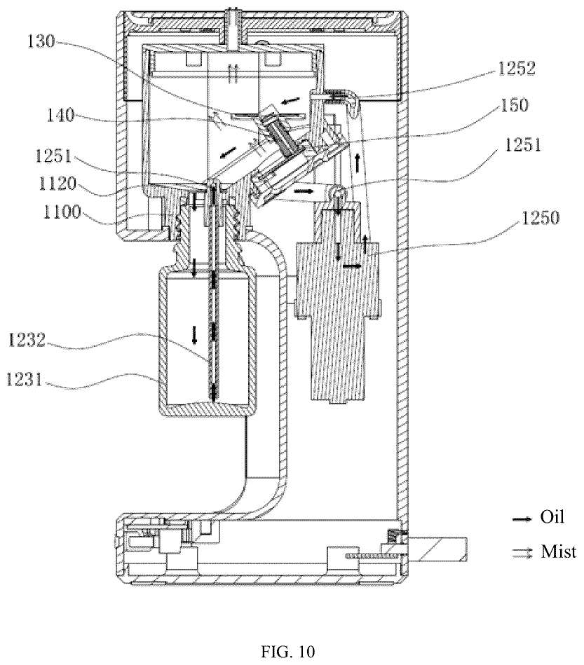

FIG. 11 is a first schematic structural diagram of an implementation in which a core component of a liquid outlet mechanism is a peristaltic pump;

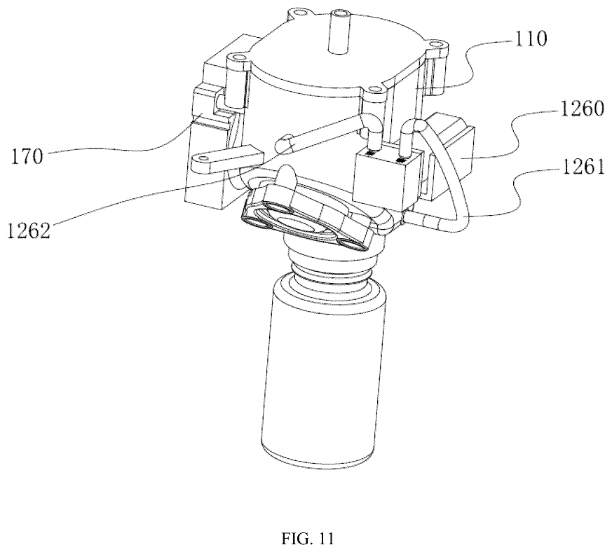

FIG. 12 is a second schematic structural diagram of an implementation in which a core component of a liquid outlet mechanism is a peristaltic pump;

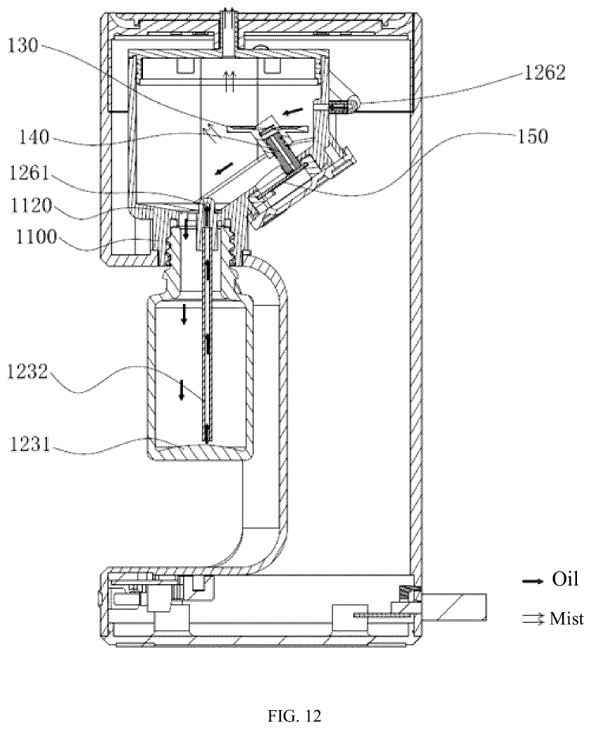

FIG. 13 is a first application scenario of the circulating liquid-guide atomization device provided in the present application;

FIG. 14 is a second application scenario of the circulating liquid-guide atomization device provided in the present application; and

FIG. 15 is a third application scenario of the circulating liquid-guide atomization device provided in the present application.

Reference numerals: 100. circulating liquid-guide atomization device; 110. housing; 111. fixing sleeve; 1111. internal thread; 1112. mounting nozzle; 112. shell; 113. upper cover; 1131. mist outlet; 114. gland; 115. sealing ring; 1151. annular limiting groove; 116. silencing sheet; 1161. through hole; 117. mist outlet channel; 120. liquid outlet mechanism; 121. air pump; 1121. air pump body; 1212. air tube; 122. venturi tube; 1221. air inlet tube section; 1222. connecting tube section; 1223. liquid inlet tube section; 1224. fixing tube section; 1225. external thread; 123. liquid storage bottle; 1231. bottle body; 1232. liquid delivery tube; 1250. water pump; 1251. water pump liquid inlet tube; 1252. water pump liquid outlet tube; 1260. peristaltic pump; 1261. peristaltic liquid inlet tube; 1262. peristaltic liquid outlet tube; 130. liquid holding tray; 131. tray body; 1311. drain outlet; 1312. guide chute; 1313. liquid blocking boss; 1314. overflow groove; 132. connecting sleeve; 1321. second annular boss; 140. liquid permeation core; 141. first annular boss; 150. atomization sheet; 160. positioning spring; and 170. fan.

### DETAILED DESCRIPTION OF THE EMBODIMENTS

In order to make objects, technical solutions and advantages of embodiments of the present application clearer, the technical solutions in the embodiments of the present application will be described clearly and completely below in conjunction with accompanying drawings in the embodiments of the present application. Obviously, the described embodiments are a part of the embodiments of the present application, not all the embodiments.

Some implementations of the present application will be described in detail below in conjunction with the accompanying drawings. Features in the following embodiments may be combined with each other without conflicts.

### Embodiment 1

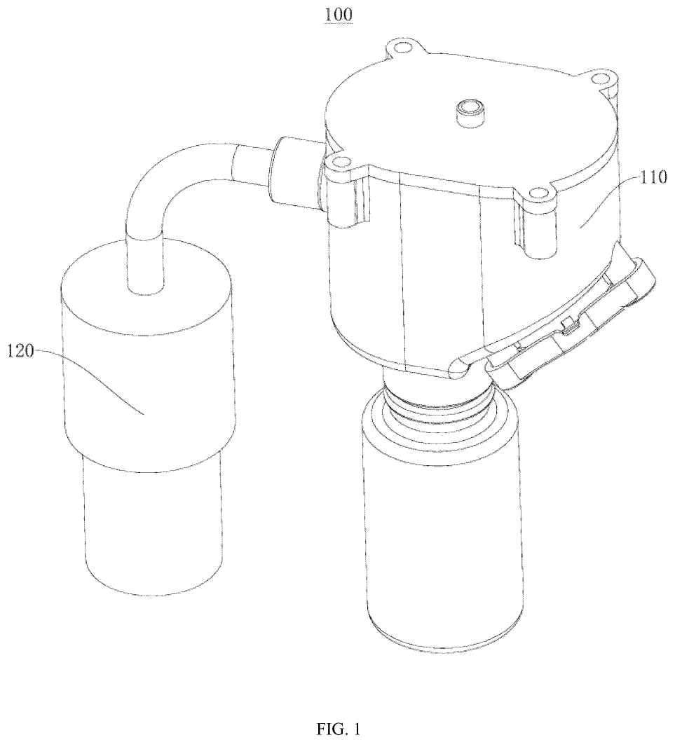

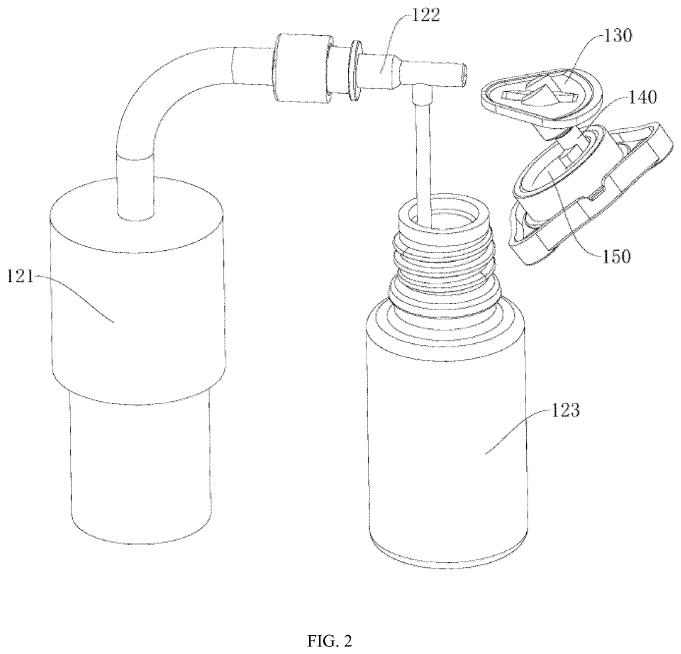

Refer to FIG. 1 and FIG. 2, an embodiment of the present application provides a circulating liquid-guide atomization device 100 for achieving a liquid atomization function, which can reasonably control a flow of a liquid, effectively reduce volumes of mist particles formed by atomization, improve an atomization effect, and improve user experience.

In the present embodiment, the liquid is an aromatherapy liquid mainly referring to aromatherapy essential oil, the circulating liquid-guide atomization device 100 is applied to the field of aromatherapy, and the aromatherapy essential oil can be sprayed outwards after being atomized by the circulating liquid-guide atomization device 100 such that a perfuming function is achieved. However, it not limited thereto, in other embodiments, the liquid may be a medicine liquid, at the time, the circulating liquid-guide atomization device 100 is applied to the medical field, and the medicine liquid can be sprayed outwards after being atomized by the circulating liquid-guide atomization device 100 so as to be inhaled by a patient; the liquid may also be an electronic cigarette liquid, at the time, the circulating liquid-guide atomization device 100 is applied to the field of electronic cigarettes, and the electronic cigarette liquid can be sprayed outwards after being atomized by the circulating liquid-guide atomization device 100 so as to be smoked by a user; and application fields of the circulating liquid-guide atomization device 100 are not specifically limited.

A circulating liquid-guide atomization device 100 includes a housing 110, a liquid outlet mechanism 120, and an atomization module mounted in the housing 100 and used for atomizing an external liquid, wherein the atomization module includes an atomization sheet 150 (it should be noted herein that the atomization module is based on a mature technology, the present application is not an improved and innovated atomization module, and a result described herein can be obtained by adopting the atomization module in the prior art so as not to be repeated herein) mounted in the housing 100, the liquid outlet mechanism 120 is connected with the housing 100 and is disposed to extend into the housing 100, the liquid outlet mechanism 120 is used for spraying the liquid onto the atomization sheet 150, and a flow of the liquid sprayed by the liquid outlet mechanism 120 is adjustable so as to be reasonably controlled.

The atomization sheet 150 is provided with a liquid permeation core 140 and a liquid holding tray 130, the liquid permeation core 140 and the liquid holding tray are both located in the housing, one end of the liquid permeation core 140 is connected with the liquid holding tray 130, the other end thereof is connected with the atomization sheet 150, a liquid outlet position of the liquid outlet mechanism is located obliquely above the liquid holding tray 130 and where a liquid is sprayed onto the liquid holding tray 130, the liquid permeation core 140 is used for guiding the liquid from the liquid holding tray 130 to the atomization sheet 150, such that the liquid is atomized by the atomization sheet 150, and mist obtained after atomization diffuses in the housing 110 and is finally sprayed outwards; and the liquid holding tray 130 is used for collecting and guiding excess liquid to flow back to an external liquid storage bottle, that is, the liquid holding tray 130 has a certain volume and can collect and guide excess liquid such that the excess liquid flows back to the liquid outlet mechanism 120 to achieve circulating guide of the liquid and ensure that the volume of the liquid in the liquid holding tray 130 falls within a certain range, thereby ensuring that a flow of the liquid flowing to the atomization sheet 150 via the liquid permeation core 140 falls within a certain range, and then playing roles in reasonably controlling the flow of the liquid, effectively reducing volumes of mist particles formed by atomization, improve an atomization effect, and improve user experience.

It should be noted herein that the liquid holding tray 130 plays a main role in receiving the liquid sprayed from the liquid outlet mechanism more intensively, and the liquid permeation core 140 plays main roles in filtering and guiding the liquid to a certain extent such that the liquid drops on the atomization sheet 150 continuously, uninterruptedly and uniformly. Preferably, a position where the liquid drops from the liquid permeation core 140 should be located above the center of the atomization sheet 150 due to an optimal atomization effect in the center of the atomization sheet 150. By such structural setting, a thin oil film can be formed stably on a surface of the atomization sheet 150 to achieve the optimal atomization effect.

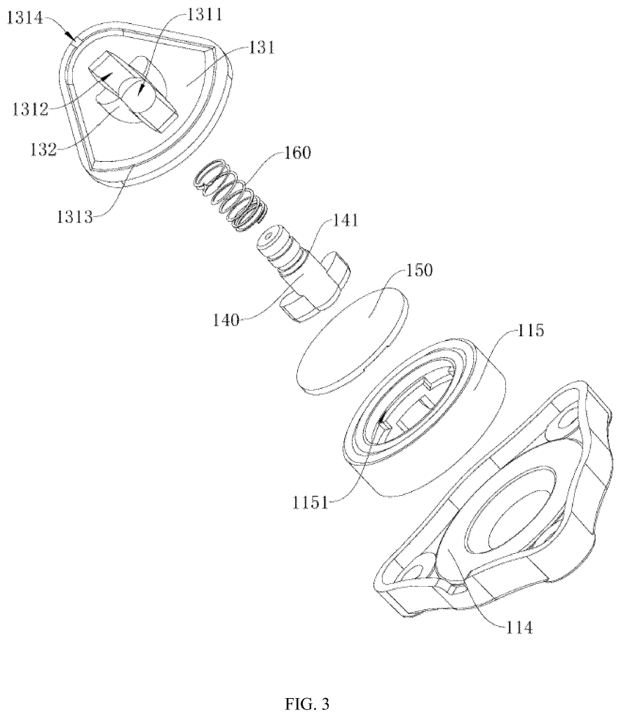

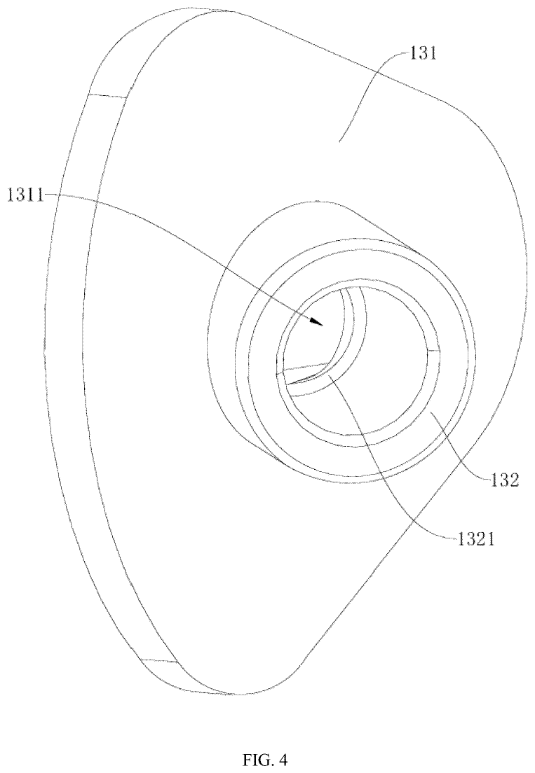

Refer to FIG. 3 and FIG. 4, the liquid holding tray 130 includes a tray body 131 and a connecting sleeve 132. A drain outlet 1311 is formed in the tray body 131, the connecting sleeve 132 is connected with the liquid holding tray 130, is disposed to penetrate through the liquid holding tray 130, and communicates with the drain outlet 1311, the tray body 131 is used for holding the liquid, and the drain outlet 1311 is used for guiding the liquid in the tray body 131 into the connecting sleeve 132. In the present embodiment, the tray body 131 and the connecting sleeve 132 are integrated such that the connecting strength is improved. Specifically, the liquid permeation core 140 is partially disposed in the connecting sleeve 132, the connecting sleeve 132 is used for limiting the liquid permeation core 140, and the connecting sleeve 132 is further used for guiding the liquid flowing out of the drain outlet 1311 to the liquid permeation core 140.

It should be noted that the liquid permeation core 140 is a porous ceramic core, that is, the liquid permeation core 140 is made of a ceramic material and is provided with a plurality of micropores (unshown in the figures) therein. Specifically, the liquid permeation core 140 is disposed to be cylindrical and is provided with a stopping layer (unshown in the figures) on a circumferential surface thereof to prevent the liquid from overflowing out of the circumferential surface of the liquid permeation core 140 and ensure that the liquid can only flow in or out from two ends of the liquid permeation core 140, thereby guaranteeing a liquid guide effect. Further, when the connecting sleeve 132 guides the liquid to the liquid permeation core 140, the liquid enters the plurality of micropores in the liquid permeation core 140 and finally flows out from an end, away from the connecting sleeve 132, of the liquid permeation core 140 to the atomization sheet 150 so as to be atomized by the atomization sheet 150. In this process, the liquid permeation core 140 can uniformly disperse the liquid via the plurality of micropores to ensure that the flow of the liquid flowing onto the atomization sheet 150 is uniform, thereby avoiding larger volumes of mist particles formed by simultaneous atomization of a great deal of liquid, and improving an atomization effect of the atomization sheet 150.

In the present embodiment, an axial direction of the connecting sleeve 132 is disposed to be inclined to a plane where the tray body 131 is located, and an axial direction of the liquid permeation core 140 is the same as the axial direction of the connecting sleeve 132 and is perpendicular to a plane where the atomization sheet 150 is located, that is, the plane where the tray body 131 is inclined to the plane where the atomization sheet 150 is located. Specifically, the plane where the tray body 131 is a horizontal plane, a preset included angle ranging from 30 DEG to 60 DEG is formed between the liquid permeation core 140 and the plane where the tray body 131 is located, and by means of the reasonable preset included angle, the liquid can flow to the atomization sheet 150 in the liquid permeation core 140 according to an appropriate speed, thereby avoiding larger volumes of mist particles formed by simultaneous atomization of a great deal of liquid, and guaranteeing an atomization effect.

In the present embodiment, a guide chute 1312 is formed in the tray body 131, the drain outlet 1311 is disposed in a bottom wall of the guide chute 1312, the bottom wall of the guide chute 1312 is gradually inclined downwards in a direction close to the drain outlet 1311, and the guide chute 1312 can guide the liquid in the tray body 131 such that the liquid flows into the drain outlet 1311 under the action of gravity and then flows to the atomization sheet 150 via the liquid permeation core 140 to guarantee the flow smoothness and stability of the liquid.

In the present embodiment, a liquid blocking boss 1313 is enclosed on an edge of the tray body 131 and is used for blocking the liquid to prevent the liquid from flowing out of the tray body 131. An overflow groove 1314 is formed in the liquid blocking boss 1313, the position of the overflow groove 1314 corresponds to the position of the liquid outlet mechanism 120, and the overflow groove 1314 is used for allowing a liquid overflowing out of the tray body 131 to flow back to the liquid outlet mechanism 120. Specifically, when a liquid level height of the liquid in the tray body 131 is greater than a bottom wall height of the overflow groove 1314, the liquid in the tray body 131 may flow outwards via the overflow groove 1314 and flow back to the liquid outlet mechanism 120 to achieve circulating guide of the liquid.

Further, the circulating liquid-guide atomization device 100 further includes a positioning spring 160. A first annular boss 141 is disposed on a circumferential surface of the liquid permeation core 140, a second annular boss 1321 is disposed in the connecting sleeve 132, the positioning spring 160 is sleeved outside the liquid permeation core 140 and is disposed in the connecting sleeve 132, axial directions of the positioning spring 160, the liquid permeation core 140 and the connecting sleeve 132 are the same, and the liquid permeation core 140 and the connecting sleeve 132 co-work to limit the positioning spring 160 so as to ensure that the positioning spring 160 can only deform in the axial direction thereof. One end of the positioning spring 160 abuts against the first annular boss 141, the other end thereof abuts against the second annular boss 1321, and the liquid permeation core 140 abuts against the atomization sheet 150. Specifically, the positioning spring 160 is always in a compressed state and can apply an elastic force to the liquid permeation core 140 via the first annular boss 141 under the abutting action of the second annular boss 1321 of the connecting sleeve 132 such that the liquid permeation core 140 presses against the atomization sheet 150 to ensure that the liquid can flow to the atomization sheet 150 smoothly and stably.

In the present embodiment, the atomization sheet 150 is an ultrasonic atomization sheet which may vibrate in a process of atomizing the liquid. The positioning spring 160 capable of playing damping and buffering roles is disposed between the liquid permeation core 140 and the connecting sleeve 132, and therefore, vibration generated by the atomization sheet 150 during operation cannot affect the liquid permeation core 140 and the liquid holding tray 130, which guarantees the reliability and durability of the entire circulating liquid-guide atomization device 100.

Further refer to FIG. 2, the liquid outlet mechanism 120 includes an air pump 121, a venturi tube 122, and a liquid storage bottle 123, the air pump 121 and the liquid storage bottle 123 are both connected with the venturi tube 122, the venturi tube 122 is mounted in the housing 110 and is disposed obliquely above the liquid holding tray 130, and the air pump 121 is used for introducing air to the venturi tube 122 so as to suck the liquid in the liquid storage bottle 123 into the venturi tube 122 and spray the liquid onto the liquid holding tray 130. Specifically, in a process that air is introduced to the venturi tube 122 by the air pump 121, the higher the flow speed of the air is, the lower the air pressure inside the venturi tube 122 is, and the air pressure is lower than the atmospheric pressure, such that the liquid in the liquid storage bottle 123 is sucked into the venturi tube 122 under the action of a pressure difference, and then, the liquid is sprayed outwards from the venturi tube 122 under the driving of the air and falls in the liquid holding tray 130, in this process, the power of the air pump 121 is adjustable, that is, the flow speed of the air in the venturi tube 122 is adjustable, the flow of the liquid sprayed from the venturi tube 122 to the liquid holding tray 130 is also adjustable, which facilitates operation and improves user experience.

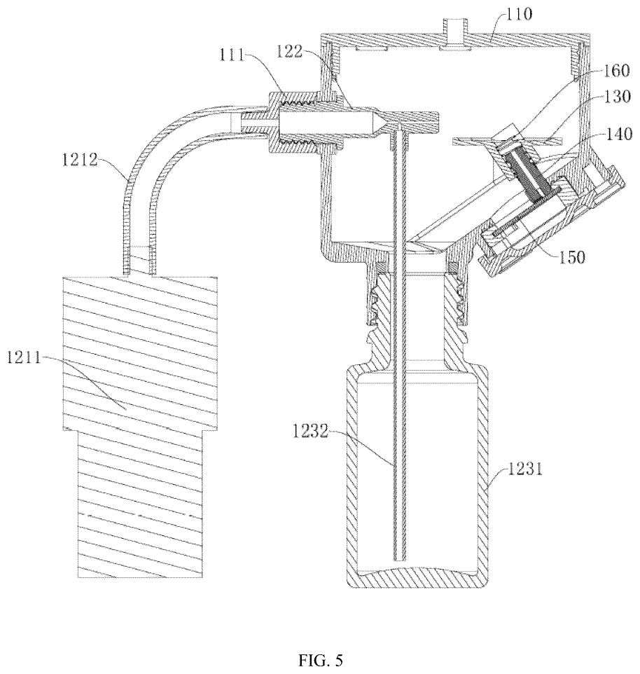

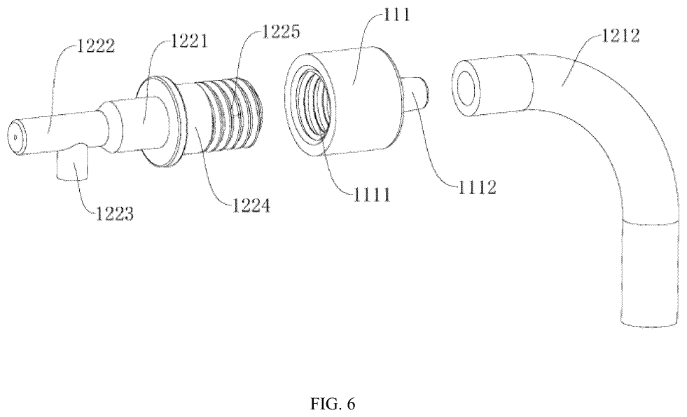

Refer to FIG. 5 and FIG. 6, the venturi tube 122 includes an air inlet tube section 1221, a connecting tube section 1222, a liquid inlet tube section 1223, and a fixing tube section 1224, wherein the air inlet tube section 1221 and the connecting tube section 1222 are coaxially disposed and are connected with each other, and the internal diameter of the air inlet tube section 1221 is greater than the internal diameter of the connecting tube section 1222. The liquid inlet tube section 1223 is connected to the connecting tube section 1222 and is disposed to be perpendicular to the connecting tube section 1222. The air inlet tube section 1221 is connected with the air pump 121, the liquid inlet tube section 1223 is connected with the liquid storage bottle 123, the connecting tube section 1222 is used for spraying the liquid onto the liquid holding tray 130, and air can be introduced to the air inlet tube section 1221 by the air pump 121 so as to be blown out in a direction close to the liquid holding tray 130 via the connecting tube section 1222, in this process, the liquid in the liquid storage bottle 123 flows into the connecting tube section 1222 via the liquid inlet tube section 1223 under the action of the pressure difference and is sprayed out in a direction close to the liquid holding tray 130 via the connecting tube section 1222 under the driving of the air.

It should be noted that the fixing tube section 1224 is connected to an end, away from the connecting tube section 1222, of the air inlet tube section 1221, the housing 110 is provided with a fixing sleeve 111 (the fixing sleeve 111 may be integrated with a shell 112 or disposed to be separated from and matched with the shell 112), the fixing tube section 1224 is disposed to penetrates through a side wall of the housing 110 and is matched with the fixing sleeve 111, and the fixing sleeve 111 can fix the position of the fixing tube section 1224, thereby fixing relative positions of the entire venturi tube 122 and the housing 110 to prevent the venturi tube 122 from displacing relative to the housing 110. Specifically, one end of the fixing sleeve 111 communicates with the air pump 121, the other end thereof communicates with the fixing tube section 1224, and the air pump 121 can be connected with the fixing tube section 1224 via the fixing sleeve 111, thereby introducing the air to the air inlet tube section 1221 to achieve an air inlet function.

In the present embodiment, the fixing tube section 1224 is provided with an external thread 1225, the fixing sleeve 111 is provided with an internal thread 1111, the external thread 1225 is matched with the internal thread 1111 to achieve detachable connection between the fixing tube section 1224 and the fixing sleeve 111, thereby achieving detachable connection between the venturi tube 122 and the housing 110, facilitating disassembly and assembly, and facilitating maintaining or replacing the venturi tube 122.

The air pump 121 includes an air pump body 1211 and an air tube 1212. The fixing sleeve 111 axially extends to be provided with a mounting nozzle 1112, one end of the air tube 1212 is connected with the air pump body 1211, and the other end thereof is sleeved outside the mounting nozzle 1112 and is matched with the mounting nozzle 1112. Specifically, the air tube 1212 is in interference fit with the mounting nozzle 1112, and the mounting nozzle 1112 is used for achieving detachable connection between the air tube 1212 and the fixing sleeve 111 such that the air pump 121 and the housing 110 are disassembled; and the air tube 1212 is used for communicating the air pump body 1211 and the fixing sleeve 111, and the air pump body 1211 can blow air into the air inlet tube section 1221 sequentially via the air tube 1212, the fixing sleeve 111, and the fixing tube section 1224.

The liquid storage bottle 123 includes a bottle body 1231 and a liquid delivery tube 1232. The bottle body 1231 is connected with the housing 110 and is used for storing the liquid. One end of the liquid delivery tube 1232 is disposed to extend into the bottle body 1231 and extend to the downside of the liquid level of the liquid, and the other end of the liquid delivery tube 1232 is disposed to extend into the liquid inlet tube section 1223 and is matched with the liquid inlet tube section 1223. Specifically, the liquid delivery tube 1232 is in interference fit with the liquid inlet tube section 1223, such that detachable connection between the liquid delivery tube 1232 and the liquid inlet tube section 1223 is achieved, and it is convenient to disassemble the liquid delivery tube 1232 and the liquid inlet tube section 1223, and the liquid delivery tube 1232 is used for delivering the liquid in the bottle body 1231 to the liquid inlet tube section 1223.

In the present embodiment, the bottle body 1231 is disposed below the housing 110 and is in threaded connection with the housing 110, such that detachable connection between the bottle body 1231 and the housing 110 is achieved, then, it is convenient to replace the bottle body 1231, and a role in supplementing the liquid is played. Specifically, an opening of the bottle body 1231 is located under the overflow groove 1314, the liquid flowing out of the overflow groove 1314 can vertically flow downwards under the action of gravity and flows into the bottle body 1231 via the opening of the bottle body 1231 such that a backflow function of the liquid is achieved.

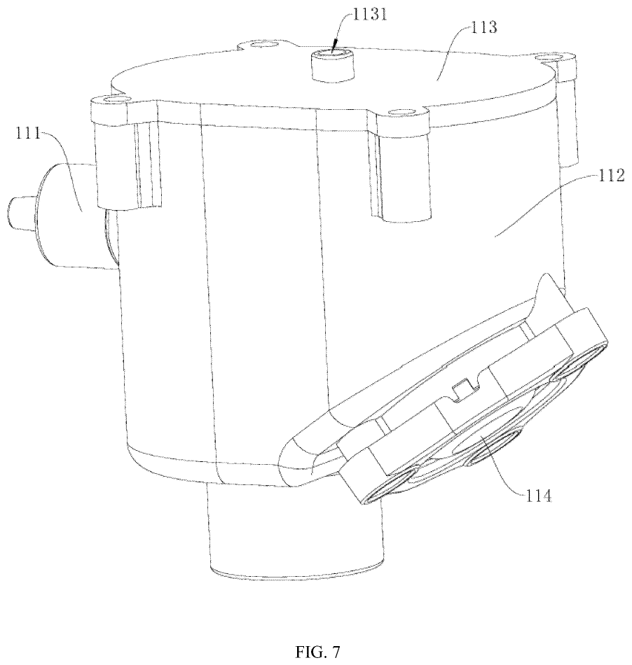

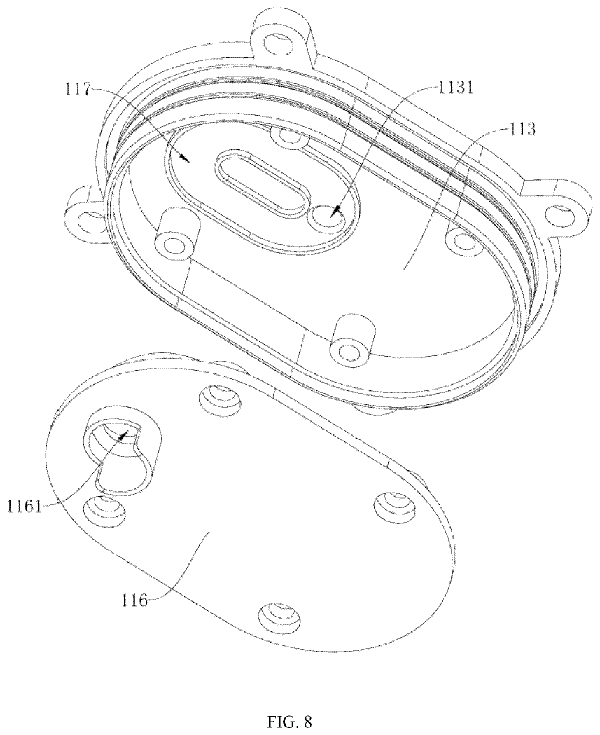

Refer to FIG. 3, FIG. 7 and FIG. 8, the housing 110 includes a shell 112, an upper cover 113, a gland 114, a sealing ring 115, and a silencing sheet 116. The upper cover 113 and the gland 114 are both connected to the shell 112, a mist outlet 1131 is formed in the upper cover 113, and mist in the shell 112 can be sprayed outwards via the mist outlet 1131 in the upper cover 113 such that a perfuming function is achieved. The gland 114 is connected with the scaling ring 115 so as to fix relative positions of the sealing ring 115 and the entire housing 110 to prevent the sealing ring 115 from falling out of the housing 110. An annular limiting groove 1151 is formed in an inner side wall of the sealing ring 115, the atomization sheet 150 is clamped in the annular limiting groove 1151, and the annular limiting groove 1151 can limit and fix the atomization sheet 150 to prevent the atomization sheet 150 from displacing relative to the scaling ring 115, thereby guaranteeing an atomization effect of the atomization sheet 150.

The housing 110 includes a shell 112, a housing connecting section 1100 is formed on a position where the shell 112 is connected with the external liquid storage bottle, and an inner wall 1120, close to the housing connecting section, of the shell 112 is obliquely disposed and forms the lowest position on the position where the housing connecting section 1100 is connected. By disposing such a housing structure, the liquid dispersed in the shell and not completely atomized during atomization can blow back to the external liquid storage bottle 123 along such an inclined inner wall 1120 of the shell 112.

Further, the silencing sheet 116 is mounted on an inner side of the upper cover 113 and forms a mist outlet channel 117 together with the upper cover 113, and the silencing sheet 116 is used for absorbing noise generated by the flowing of the air and the liquid in the shell 112 so as to achieve silencing and noise reducing functions and improve user experience. Specifically, a through hole 1161 is formed in the silencing sheet 116, the through hole 1161 communicates with the mist outlet 1131 via the mist outlet channel 117, the mist generated in the shell 112 can be sprayed outwards sequentially via the through hole 1161, the mist outlet channel 117 and the mist outlet 1131, and the mist outlet channel 117 is used for extending a low path of the mist, reducing the flow speed of the mist and reducing noise generated by the flowing of the mist, thereby further reducing noise generated when the entire circulating liquid-guide atomization device runs, and improving user experience.

In the present embodiment, the mist outlet channel 117 is an annular channel, the through hole 1161 and the mist outlet 1131 are oppositely disposed on two sides of the mist outlet channel 117, the mist entering the mist outlet channel 117 via the through hole 1161 can flow in two paths to a direction close to the mist outlet 1131, and is finally sprayed outwards via the mist outlet 1131, such that the flow speed of the mist is further reduced, and the noise generated by the flowing of the mist is reduced.

Further, a fan 170 is fixedly mounted on one side of the housing 110, and an air outlet of the fan is connected with an inner cavity of the shell 112. During atomization, a user can voluntarily select whether to start the fan 170, and when the fan 170 is started, the motion of molecules in the shell 112 can be accelerated, such that the atomized mist can be dispersed more uniformly and rapidly.

According to the circulating liquid-guide atomization device 100 provided by the embodiment of the present application, the liquid holding tray 130, the liquid permeation core 140 and the atomization sheet 150 are all mounted in the housing 110, one end of the liquid permeation core 140 is connected with the liquid holding tray 130, the other end thereof is connected with the atomization sheet 150, the liquid outlet mechanism 120 is connected with the housing 110 and is disposed to extend into the housing 110, the position of the liquid outlet mechanism 120 corresponds to the position of the liquid holding tray 130, the liquid outlet mechanism 120 is used for spraying a liquid onto the liquid holding tray 130, the liquid permeation core 140 is used for guiding the liquid to the atomization sheet 150 such that the liquid is atomized by the atomization sheet 150, and the liquid holding tray 130 is used for collecting and guiding excess liquid such that the excess liquid flows back to the liquid outlet mechanism 120. Compared with the prior art, due to the adoption of the liquid outlet mechanism 120 with the position corresponding to the position of the liquid holding tray 130 and the atomization sheet 150 connected with the liquid holding tray 130 via the liquid permeation core 140, the circulating liquid-guide atomization device 100 provided by the present application can reasonably control a flow of a liquid, effectively reduce volumes of mist particles formed by atomization, improve an atomization effect, and improve user experience.

### Embodiment 2

Different from embodiment 1, the liquid outlet mechanism 120 includes a water pump 1250, a water pump liquid inlet tube 1251, and a water pump liquid outlet tube 1252, two ends of the water pump liquid inlet tube 1251 are respectively connected with the water pump 1250 and the liquid delivery tube 1232 of the external liquid storage bottle 123, two ends of the water pump liquid outlet tube 1252 are respectively connected with the water pump 1250 and the housing 110, the end connected with the housing 110 is located obliquely above the liquid holding tray 130, and the water pump 1250 is used for sucking the liquid in the liquid storage bottle 123 into the water pump liquid outlet tube and spraying the liquid onto the liquid holding tray 130.

### Embodiment 3

Different from embodiment 1, the liquid outlet mechanism includes a peristaltic pump 1260, a peristaltic liquid inlet tube 1261, and a peristaltic liquid outlet tube 1262, two ends of the peristaltic liquid inlet tube 1261 are respectively connected with the peristaltic pump 1260 and the liquid delivery tube 1232 of the external liquid storage bottle 123, two ends of the peristaltic liquid outlet tube 1262 are respectively connected with the peristaltic pump and the housing 110, the end connected with the housing 110 is located obliquely above the liquid holding tray 130, and the peristaltic pump 1260 is used for sucking the liquid in the liquid storage bottle 123 into the peristaltic liquid outlet tube 1262 and spraying the liquid onto the liquid holding tray 130.

### Embodiment 4

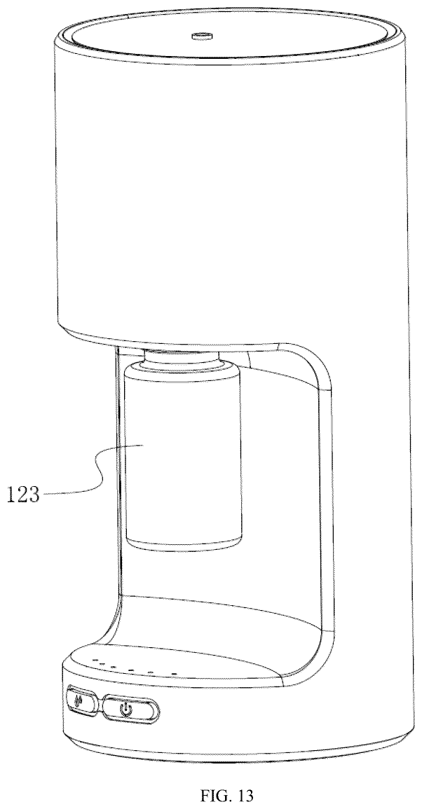

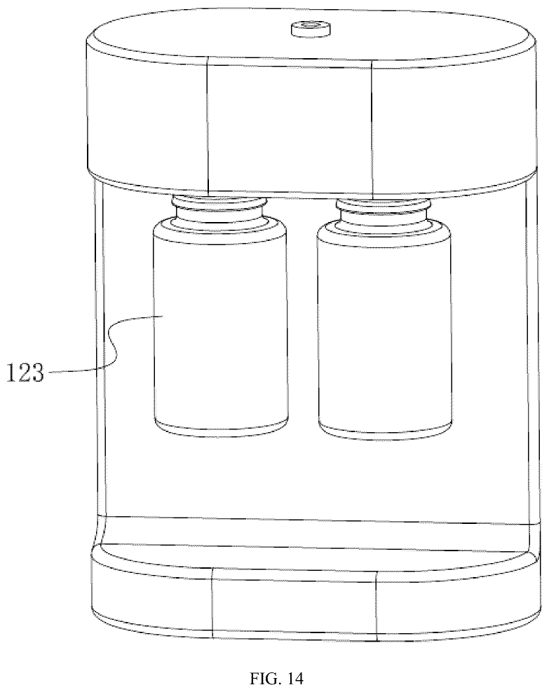

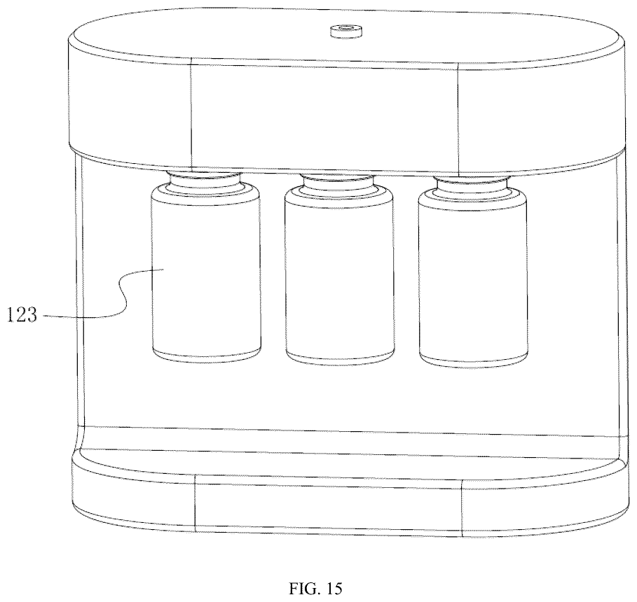

As shown in FIGS. 13-15, the circulating liquid-guide atomization device 100 provided in the present application is applied to an aromatherapy machine, and during application, one aromatherapy essential oil bottle, two aromatherapy essential oil bottles or three aromatherapy essential oil bottles may be carried, or more aromatherapy essential oil bottles may be carried.

It should be noted that when one aromatherapy machine carries at least two aromatherapy essential oil bottles, there may be a set of liquid outlet mechanism, the number of the atomization modules and the number of the aromatherapy essential oil bottle are kept consistent, a plurality of channels are disposed on the drain outlet, and the different channels correspond to the different atomization modules. However, in order to keep the independence of mist obtained by atomization, the different aromatherapy essential oil bottles may work independently, preferably, when one aromatherapy machine carries at least two aromatherapy essential oil bottles, both of the number of the liquid outlet mechanism and the number of the atomization modules correspond to the number of the aromatherapy essential oil bottles one to one.

The above descriptions are merely preferred embodiments of the present application, but are not intended to limit the present application. Various alterations and variations may be made on the present application by the skilled in the art. Any modifications, equivalent substitutions, improvements, etc. made within the spirit and principle of the present application shall fall within the protection scope of the present application.

What is claimed is:

1. A circulating liquid-guide atomization device, comprising a housing, a liquid outlet mechanism, and an atomization module mounted in the housing and used for atomizing an external liquid, wherein the atomization module comprises an atomization sheet mounted in the housing, the liquid outlet mechanism is connected with the housing and is disposed to extend into the housing, and the liquid outlet mechanism is used for spraying the liquid onto the atomization sheet.

2. The circulating liquid-guide atomization device of claim 1, wherein the atomization sheet is provided with a liquid permeation core and a liquid holding tray, the liquid permeation core and the liquid holding tray are both located in the housing, one end of the liquid permeation core is connected with the liquid holding tray, the other end thereof is connected with the atomization sheet, a liquid outlet position of the liquid outlet mechanism is located above the liquid holding tray and where a liquid is sprayed onto the liquid holding tray, the liquid permeation core is used for guiding the liquid from the liquid holding tray to the atomization sheet such that the liquid is atomized by the atomization sheet, and the liquid holding tray is used for collecting and guiding excess liquid to flow back to an external liquid storage bottle.

3. The circulating liquid-guide atomization device of claim 2, wherein the liquid holding tray comprises a tray body and a connecting sleeve, a drain outlet is formed in the tray body, the connecting sleeve is connected with the liquid holding tray, is disposed to penetrate through the liquid holding tray, and communicates with the drain outlet, and the liquid permeation core is partially disposed in the connecting sleeve.

4. The circulating liquid-guide atomization device of claim 3, wherein an axial direction of the connecting sleeve is disposed to be inclined to a plane where the tray body is located, and an axial direction of the liquid permeation core is the same as the axial direction of the connecting sleeve and is perpendicular to a plane where the atomization sheet is located.

5. The circulating liquid-guide atomization device of claim 3, wherein a guide chute is formed in the tray body, the drain outlet is disposed in a bottom wall of the guide chute, and the bottom wall of the guide chute is gradually inclined downwards in a direction close to the drain outlet.

6. The circulating liquid-guide atomization device of claim 3, wherein a liquid blocking boss is enclosed on an edge of the tray body, an overflow groove is formed in the liquid blocking boss, the position of the overflow groove corresponds to the position of the liquid outlet mechanism, and the overflow groove is used for allowing a liquid overflowing out of the tray body to flow back to the liquid outlet mechanism.

7. The circulating liquid-guide atomization device of claim 2, wherein the liquid permeation core is further connected with a positioning spring, a first annular boss is disposed on a circumferential surface of the liquid permeation core, a second annular boss is disposed in the connecting sleeve, the positioning spring is sleeved outside the liquid permeation core and is disposed in the connecting sleeve, one end of the positioning spring abuts against the first annular boss, the other end thereof abuts against the second annular boss, and the liquid permeation core abuts against the atomization sheet.

8. The circulating liquid-guide atomization device of claim 1, wherein the liquid outlet mechanism comprises an air pump, a venturi tube, and a liquid storage bottle, the air pump and the liquid storage bottle are both connected with the venturi tube, the venturi tube is mounted in the housing and is disposed obliquely above the liquid holding tray, and the air pump is used for introducing air to the venturi tube so as to suck the liquid in the liquid storage bottle into the venturi tube and spray the liquid onto the liquid holding tray.

9. The circulating liquid-guide atomization device of claim 8, wherein the venturi tube comprises an air inlet tube section, a connecting tube section, and a liquid inlet tube section, wherein the air inlet tube section and the connecting tube section are coaxially disposed and are connected with each other, the internal diameter of the air inlet tube section is greater than the internal diameter of the connecting tube section, the liquid inlet tube section is connected to the connecting tube section and is disposed to be perpendicular to the connecting tube section, the air inlet tube section is connected with the air pump, the liquid inlet tube section is connected with the liquid storage bottle, and the connecting tube section is used for spraying the liquid onto the liquid holding tray.

10. The circulating liquid-guide atomization device of claim 1, wherein the liquid outlet mechanism comprises a water pump, a water pump liquid inlet tube, and a water pump liquid outlet tube, two ends of the water pump liquid inlet tube are respectively connected with the water pump and a liquid delivery tube of the external liquid storage bottle, two ends of the water pump liquid outlet tube are respectively connected with the water pump and the housing, the end connected with the housing is located obliquely above the liquid holding tray, and the water pump is used for sucking the liquid in the liquid storage bottle into the water pump liquid outlet tube and spraying the liquid onto the liquid holding tray.

11. The circulating liquid-guide atomization device of claim 1, wherein the liquid outlet mechanism comprises a peristaltic pump, a peristaltic liquid inlet tube, and a peristaltic liquid outlet tube, two ends of the peristaltic liquid inlet tube are respectively connected with the peristaltic pump and the liquid delivery tube of the external liquid storage bottle, two ends of the peristaltic liquid outlet tube are respectively connected with the peristaltic pump and the housing, the end connected with the housing is located obliquely above the liquid holding tray, and the peristaltic pump is used for sucking the liquid in the liquid storage bottle into the peristaltic liquid outlet tube and spraying the liquid onto the liquid holding tray.

12. The circulating liquid-guide atomization device of claim 1, wherein the housing comprises a shell, an upper cover, a gland, and a sealing ring, the upper cover and the gland are both connected to the shell, a mist outlet is formed in the upper cover, the gland is connected with the sealing ring, an annular limiting groove is formed in an inner side wall of the sealing ring, and the atomization sheet is clamped in the annular limiting groove.

13. The circulating liquid-guide atomization device of claim 12, wherein the housing further comprises a silencing sheet, the silencing sheet is mounted on an inner side of the upper cover and forms a mist outlet channel together with the upper cover, a through hole is formed in the silencing sheet, and the through hole communicates with the mist outlet via the mist outlet channel.

14. The circulating liquid-guide atomization device of claim 1, wherein the housing comprises a shell, a housing connecting section is formed on a position where the shell is connected with the external liquid storage bottle, and an inner wall, close to the housing connecting section, of the shell is obliquely disposed and forms the lowest position on a position where the housing connecting section is connected.

15. The circulating liquid-guide atomization device of claim 1, wherein a fan is mounted on one side of the housing, and an air outlet of the fan is connected with an inner cavity of the housing.
